(19) United States
(12) Patent Application Publication
(10) Pub. No.: US 2026/0364451 A1
(43) Pub. Date: Nov. 19, 2026

(54) GAME CONTROL METHOD AND APPARATUS, AND TERMINAL DEVICE AND STORAGE MEDIUM

(71) Applicant: NETEASE (HANGZHOU) NETWORK CO., LTD., Hangzhou (CN)

(72) Inventor: Xizi SU, Hangzhou (CN)

(21) Appl. No.: 19/142,601

(22) PCT Filed: May 22, 2023
(86) PCT No.: PCT/CN2023/095480

§ 371 Date: Jun. 23, 2025

(30) Foreign Application Priority Data
Dec. 23, 2023 (CN) 202211668256.0

(51) Int. Cl. A63F 13/53; A63F 13/837

(52) U.S. Cl. CPC A63F 13/53; A63F 13/837; A63F 2300/308

(57) ABSTRACT

The present disclosure provides a game control method, including: in response to a aiming control operation, acquiring an operation parameter of the aiming control operation; controlling a movement distance of a front sight based on the operation parameter, where the operation parameter is positively correlated to the movement distance, and the front sight is an aiming mark displayed via a graphical user interface; determining that a front sight precise control condition is met; and in response to a precise sighting control operation, controlling the front sight to move by a first preset distance.

### CROSS-REFERENCE TO RELATED APPLICATION

The present disclosure is a 371 national phase application of PCT Application No. PCT/CN 2023/095480 filed May 22, 2023, which claims priority to Chinese Patent Application No. 202211668256.0 filed with the China National Intellectual Property Administration on 23 Dec. 2022 and titled “METHOD FOR GAME CONTROL, APPARATUS FOR GAME CONTROL, TERMINAL DEVICE, AND STORAGE MEDIUM”, the entire content of both of which applications are incorporated herein by reference.

### TECHNICAL FIELD

The present disclosure relates to games, and specifically relates to a method for game control.

### BACKGROUND

At present, in most games, such as shooting games, a front sight of a controlled virtual object can be moved to aim at and shoot at a target virtual object.

However, when a player controls the front sight to move, the closer the distance between the front sight and the target virtual object is, the higher the precision requirements for controlling the front sight to move by the player are. The player needs to control the front sight with high accuracy to aim at the target, which requires the player to have a strong micro-operation skills and negatively affects the game experience of the player. This can increase the duration of a game round, increase power consumption of the terminal, and impose additional operational load on the server.

### SUMMARY

The present disclosure provides a method, system, and apparatus for game control, thereby reducing the difficulty for a player in controlling a front sight to aim at a target object.

According a first aspect, the present disclosure provides a method for game control, including: acquiring, in response to an aiming control operation, an operation parameter of the aiming control operation, where a graphical user interface is provided by a terminal device, the graphical user interface comprising a game scenario and a controlled virtual object located in the game scenario, the controlled virtual object corresponding to the terminal device; controlling a movement distance of a front sight based on the operation parameter, where the operation parameter is positively correlated with the movement distance, and the front sight is an aiming mark displayed via the graphical user interface; determining that a condition for precise control of the front sight is satisfied; and controlling, in response to a precise aiming control operation, the front sight to move constantly by a first preset distance.

According to a third aspect, the present disclosure provides a system including one or more memory collectively containing one or more programs, and one or more processors, where the one or more processors are configured to, individually or collectively, to perform one or more steps of the method for game control according to any one embodiment in the first aspect.

According to a third aspect, the present disclosure provides one or more non-transitory computer-readable storage media containing, in any combination, computer program code that, when executed by a computer system, perform one or more steps of the method for game control according to any one embodiment in the first aspect.

### BRIEF DESCRIPTION OF THE DRAWINGS

To more clearly describe technical solutions of embodiments of the present disclosure, drawings to be used in the embodiments will be briefly introduced below, and it should be understood that the following drawings only show some embodiments of the present disclosure, and therefore should not be viewed as limiting the scope of the present disclosure. For those of ordinary skills in the art, other relevant drawings may also be obtained based on these drawings without creative work.

FIG. 1 is a schematic diagram of a graphical user interface provided in one of embodiments of the present disclosure;

FIG. 2 is a schematic flowchart I of a method for game control provided in one of embodiments of the present disclosure;

FIG. 3 is a schematic flowchart II of a method for game control provided in one of embodiments of the present disclosure;

FIG. 4 is a schematic flowchart III of a method for game control provided in one of embodiments of the present disclosure;

FIG. 5 is a schematic diagram of front sight movement provided in one of embodiments of the present disclosure;

FIG. 6 is a schematic diagram of increasing height of a physical rocker provided in one of embodiments of the present disclosure;

FIG. 7 is a schematic flowchart IV of a method for game control provided in one of embodiments of the present disclosure;

FIG. 8 is a schematic flowchart V of a method for game control provided in one of embodiments of the present disclosure;

FIG. 9 is a schematic flowchart VI of a method for game control provided in one of embodiments of the present disclosure;

FIG. 10 is a schematic flowchart VII of a method for game control provided in one of embodiments of the present disclosure;

FIG. 11 is a schematic structural diagram of an apparatus for game control provided in one of embodiments of the present disclosure; and

FIG. 12 is a schematic diagram of a terminal device provided in one of embodiments of the present disclosure.

### DETAILED DESCRIPTION

In order to make objectives, technical solutions, and advantages of embodiments of the present disclosure clearer, the technical solutions in the embodiments of the present disclosure will be clearly and completely described below with reference to the drawings in the embodiments of the present disclosure. Apparently, the described embodiments are some, instead of all, of the embodiments of the present disclosure.

Therefore, the following detailed description of the embodiments of the present disclosure provided in the drawings is not intended to limit the scope of the present disclosure, but merely represents selected embodiments of the present disclosure. All other embodiments obtained by those of ordinary skills in the art based on the embodiments of the present disclosure without creative work are encompassed within the scope of protection of the present disclosure.

In addition, the terms such as “first” and “second” in the description, the claims, and the above drawings of the present disclosure are used to distinguish between similar objects, and are not necessarily used to describe a particular sequence or a sequential order. It should be understood that the data used in such a way is interchangeable under appropriate circumstances so that the embodiments of the present disclosure described herein can be implemented in a sequence other than those illustrated or described herein. In addition, the terms “comprising” and “having”, as well as any variations thereof, are intended to encompass non-exclusive inclusions. For example, processes, methods, systems, products, or devices that include a series of steps or units are not necessarily limited to the explicitly listed steps or units, but may include other steps or units that are not explicitly listed or are inherent to these processes, methods, products, or devices.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

It should be noted that the features in the embodiments the present disclosure may be combined with each other in the case of no conflict.

At present, in most games, such as shooting games, a front sight of a controlled virtual object can be controlled to move, to aim at and shoot at a target virtual object.

However, when a player controls the front sight to move, the closer the distance between the front sight and the target virtual object is, the higher the precision requirements for controlling the front sight to move by the player are. Only by particularly precisely controlling the front sight to move, can the player ensure that the target virtual object is aimed at, which requires the player to have a strong micro-operation ability, and is not conducive to game experience of the player.

Based on the technical problems existing in the above related art, the present disclosure is intended to provide a method for game control, an apparatus for game control, a terminal device, and a storage medium, which control, based on an operation parameter corresponding to an aiming control operation, a front sight to move based on a movement distance corresponding to the operation parameter, and control, after determining that a condition for precise control of the front sight is satisfied and in response to a precise aiming control operation, the front sight to move by a constant first preset distance, so that a player operates to aim at a target virtual object through a plurality of precisely described control operations, thereby reducing the requirements for the player's operation ability and the difficulty in precise control, not only improving the game experience of the player, but also facilitating the promotion of a game to more ordinary users for experience, reducing the game round duration, reducing the power consumption of the terminal, and reducing the operation pressure of a server.

The method for game control in one of embodiments of the present disclosure may run on a local terminal device or server. When the method for game control runs on the server, the method may be implemented and executed based on a cloud interaction system, where the cloud interaction system comprises a server and a client device.

In one embodiment, various cloud applications, such as a cloud game, may run under the cloud interaction system. Taking the cloud game as an example, the cloud game refers to a game mode based on cloud computing. In an operating mode of the cloud game, an entity for operating a game program and an entity for presenting a game screen are separated. The storage and operation of the method for skill release are completed on a cloud game server. The client device functions to receive data, transmit data, and present the game screen. For example, the client device may be a display device with data transmission function in the vicinity of the user side, such as a mobile terminal, a television set, a computer, or a palm computer. However, a cloud game server in cloud performs information processing. When playing a game, the player operates the client device to transmit an operating instruction to the cloud game server. The cloud game server runs the game based on the operating instruction, encodes and compresses data such as the game screen, returns the data to the client device through a network, and finally decodes the data and outputs the game screen through the client device.

In one embodiment, taking the game as an example, the local terminal device stores the game program, and is configured to present the game screen. The local terminal device is configured to interact with the player through a graphical user interface, namely, the game program is downloaded, installed and operated through a terminal device conventionally. The local terminal device provides the graphical user interface for the player in various modes, for example, it can be rendered and displayed on a display screen of a terminal, or it is provided for the player through holographic projection. For example, the local terminal device may comprise a display screen and a processor. The display screen is configured to present the graphical user interface. The graphical user interface comprises the game screen. The processor is configured to run the game, generate the graphical user interface, and control display of the graphical user interface on the display screen.

The present disclosure provides a method, system, and apparatus for game control. After determining that a condition for precise control of a front sight is satisfied and in response to a single precise aiming control operation for a preset movement control element in a graphical user interface, the front sight is moved by a constant first preset distance. Through the disclosed approach, the player may aim at a target virtual object through a plurality of precise aiming control operations. The disclosed approach reduces the requirements for the player's operation ability and the difficulty in precise control, improves the game experience of the player, facilitates the promotion of a game to more ordinary users for experience, reduces the game round duration, reduces the power consumption of the terminal, and reduces the operation pressure of a server.

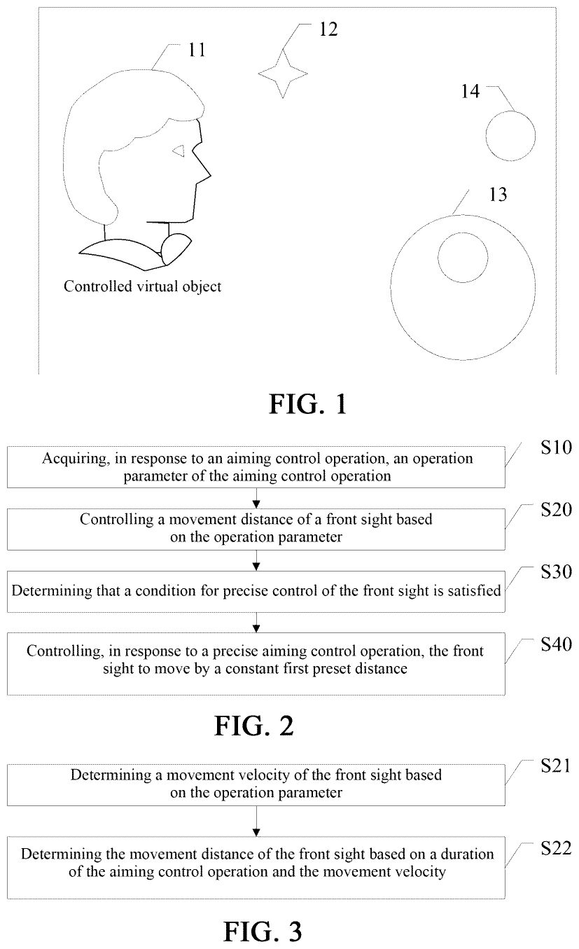

In one embodiment, an embodiment of the present disclosure provides a method for game control, providing a graphical user interface through a terminal device, where the terminal device may be the aforementioned local terminal device, or may be the client device in the aforementioned cloud interaction system. Referring to FIG. 1, which is a schematic diagram of a graphical user interface provided in an embodiment of the present disclosure. As shown in FIG. 1, the graphical user interface comprises a game scenario and a controlled virtual object 11 located in the game scenario. The controlled virtual object corresponds to a terminal device. The controlled virtual object 11 has a front sight 12, the front sight 12 is an aiming mark displayed on the graphical user interface, and a player can control the controlled virtual object 11 to move in the game scenario through the terminal device, so that the front sight 12 performs aiming in the game scenario.

Referring to FIG. 2, which is a schematic flowchart I of a method for game control provided in an embodiment of the present disclosure. As shown in FIG. 2, the method may comprise S10: acquiring, in response to an aiming control operation, an operation parameter of the aiming control operation.

In this embodiment, the aiming control operation is an operation of the controlled virtual object aiming at a target virtual object, and the operation parameter corresponding to the aiming control operation may be an operation distance corresponding to the aiming control operation. The target virtual object is a virtual object that the controlled virtual object needs to aim at and release a skill. After the target virtual object appears in the visual field of the controlled virtual object, the player inputs the aiming control operation through the terminal device, and the terminal device determines the operation distance corresponding to the aiming control operation.

S20: controlling a movement distance of a front sight based on the operation parameter.

The operation parameter is positively correlated with the movement distance, and the front sight is an aiming mark displayed on a graphical user interface. The movement distance corresponding to the operation parameter is determined based on a corresponding relationship between the operation parameter and the movement distance, the operation parameter of the aiming control operation, the controlled virtual object is controlled to move in a game scenario based on the movement distance, and the front sight moves by the corresponding movement distance in the graphical user interface as the controlled virtual object moves.

In some possible implementations, the operation parameter of the aiming control operation is the operation distance, the operation distance is positively correlated with the movement distance, and the movement distance of the front sight is determined based on the operation distance of the aiming control operation. Movement direction of the front sight is consistent with operation direction of the aiming control operation.

A possible implementation of controlling the movement distance of the front sight based on the operation parameter is described below with reference to FIG. 3.

Referring to FIG. 3, which is a schematic flowchart II of a method for game control provided in an embodiment of the present disclosure. As shown in FIG. 3, the above step S20 of controlling the movement distance of the front sight based on the operation parameter may comprise the following steps.

S21: determining a movement velocity of the front sight based on the operation parameter.

S22: determining the movement distance of the front sight based on a duration of the aiming control operation and the movement velocity.

In this embodiment, the operation parameter is an operation velocity of the aiming control operation, and the operation velocity of the aiming control operation is positively correlated with the movement velocity of the front sight, the movement velocity of the front sight corresponding to the operation velocity of the aiming control operation is determined based on a preset corresponding relationship between the operation velocity and the movement velocity, and the movement distance of the front sight is calculated based on the duration of the aiming control operation and the movement velocity of the front sight.

In a possible implementation, the operation parameter is the operation distance, and the above step S21 of determining the movement velocity of the front sight based on the operation parameter may comprise determining the movement velocity of the front sight based on the operation distance, where the operation distance is positively correlated with the movement velocity.

In this embodiment, within a given operation duration, the longer the operation distance generated by the aiming control operation is, the faster the operation velocity of the aiming control operation is, the faster the movement velocity of the front sight is, and otherwise, the shorter the operation distance generated by the aiming control operation is, the slower the operation velocity of the aiming control operation is, the slower the movement velocity of the front sight is. The movement velocity of the front sight is determined based on the operation distance of the aiming control operation and a corresponding relationship between the operation distance and the movement velocity, and the movement distance of the front sight is calculated based on the duration of the aiming control operation and the movement velocity of the front sight.

S30: determining that a condition for precise control of the front sight is satisfied.

In this embodiment, the condition for precise control of the front sight is used to determine whether the controlled virtual object needs to be precisely controlled. When the player controls the controlled virtual object and the front sight to move, state of the controlled virtual object is detected to determine whether the controlled virtual object satisfies the condition for precise control of the front sight.

In a possible implementation, if the condition for precise control of the front sight is not satisfied, the movement distance corresponding to a movement operation parameter of the front sight continues to be controlled based on the aiming control operation inputted by the player.

S40: controlling, in response to a precise aiming control operation, the front sight to move by a constant first preset distance.

In this embodiment, if the condition for precise control of the front sight is satisfied, the precise control mode is entered, the aiming control operation inputted by the player is the precise aiming control operation, and the movement distance corresponding to the operation parameter of the precise aiming control operation is the constant movement distance, such as the first preset distance.

In the precise control mode, the player inputs the precise aiming control operation through the terminal device to control the front sight to move by the constant first preset distance. The player continuously inputs a plurality of precise aiming control operations in the precise control mode to move the front sight by the first preset distance a plurality of times, until the front sight is aimed at the target virtual object.

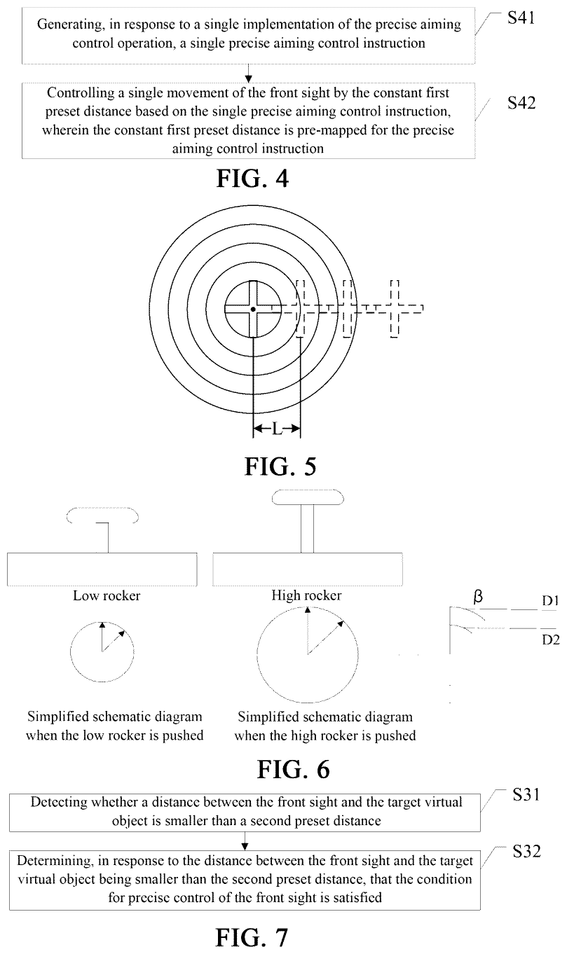

A possible implementation of controlling, in response to the precise aiming control operation, the front sight to move by the constant first preset distance is described below with reference to FIG. 4.

Referring to FIG. 4, which is a schematic flowchart III of a method for game control provided in an embodiment of the present disclosure. As shown in FIG. 4, the above step S40 of controlling, in response to the precise aiming control operation, the front sight to move by the constant first preset distance may comprise the following steps.

S41: generating, in response to a single implementation of the precise aiming control operation, a single precise aiming control instruction.

S42: controlling a single movement of the front sight by the constant first preset distance based on the single precise aiming control instruction, where the constant first preset distance is pre-mapped for the precise aiming control instruction.

In this embodiment, the precise aiming control instruction is generated based on the precise aiming control operation, and the precise aiming control instruction is pre-mapped with the constant first preset distance. Each time the player inputs a precise aiming control operation through the terminal device, a precise aiming control instruction is generated. The front sight can be controlled to move by the constant first preset distance once based on the precise aiming control instruction generated each time. When the distance between the front sight and the target virtual object is larger than the first preset distance, a plurality of precise aiming control instructions can be generated based on a plurality of precise aiming control operations. The front sight is controlled to move by the constant first preset distance a plurality of times based on the plurality of precise aiming control instructions, until the front sight is aimed at the target virtual object.

For example, referring to FIG. 5, which is a schematic diagram of the movement of the front sight. As shown in FIG. 5, in response to the plurality of precise aiming control operations, the front sight of the controlled virtual object is controlled to move by the constant first preset distance L a plurality of times, until aiming at the target virtual object.

The method for game control provided in the above embodiments comprises controlling, based on the operation parameter corresponding to the aiming control operation, the front sight to move based on the movement distance corresponding to the operation parameter, and controlling, after determining that the condition for precise control of the front sight is satisfied and in response to the precise aiming control operation, the front sight to move by the constant first preset distance, so that a player aims at the target virtual object through a plurality of precise aiming control operations, thereby reducing the requirements for the player's operation ability and the difficulty in precise control, not only improving the game experience of the player, but also facilitating the promotion of a game to more ordinary users for experience, reducing the game round duration, reducing the power consumption of the terminal, and reducing the operation pressure of a server.

In a possible implementation, in a scenario where the player directly interacts with and controls the game scenario through the terminal device, as shown in FIG. 1, the graphical user interface comprises a preset movement widget 13, and the player inputs the aiming control operation through the preset movement widget 13 to control the front sight to move by a certain movement distance. The farther the player pushes the preset movement widget 13 to move, the larger the movement distance of the front sight is. When the front sight is close to the target virtual object, if the player needs to aim the front sight at the target virtual object, the player needs to push the preset movement widget 13 very restrainedly and cautiously, thereby ensuring that the front sight is adjusted by a micro-distance in the game scenario. However, since this operation requires a high control ability of the player, it is difficult for the player to achieve precise aiming, thereby bringing negative game experience to the player.

One embodiment of the present disclosure is intended to provide a solution for achieving precise aiming in the scenario where the player directly interacts with and controls the game scenario through the terminal device. In this embodiment, the above step S41 of generating, in response to the single implementation of the precise aiming control operation, the single precise aiming control instruction may comprise generating, in response to the single implementation of the precise aiming control operation for a preset movement widget in the graphical user interface, the single precise aiming control instruction.

In this embodiment, in a scenario where the player directly interacts with and controls the game scenario through the terminal device, as shown in FIG. 1, the graphical user interface comprises a preset movement widget 13. The player inputs the aiming control operation through the preset movement widget 13 to control the front sight to move by a certain movement distance, and enters the precise control mode after determining that the condition for precise control of the front sight is satisfied. The player's control operation for the preset movement widget 13 is the precise aiming control operation, the single precise aiming control instruction is generated based on the single precise aiming control operation inputted by the player through the preset movement widget 13, and the front sight is controlled to move by the constant first preset distance once based on the single precise aiming control instruction.

The method for game control provided in the above embodiments comprises controlling, after determining that the condition for precise control of the front sight is satisfied and in response to the single precise aiming control operation for the preset movement widget in the graphical user interface, the front sight to move by the constant first preset distance, so that the player aims at the target virtual object through a plurality of precise aiming control operations, thereby reducing the requirements for the player's operation ability and the difficulty in precise control, not only improving the game experience of the player, but also facilitating the promotion of the game to more ordinary users for experience, reducing the game round duration, reducing the power consumption of the terminal, and reducing the operation pressure of the server.

In another possible implementation, in a scenario where the player interacts with and controls the game scenario through a gamepad, the gamepad is communicatively connected to the terminal device, and the terminal device controls, after receiving an operation inputted by the player through a physical rocker and a button on the gamepad, the controlled virtual object to move or execute a command in the game scenario, so as to control the front sight of the controlled virtual object to be aimed at the target virtual object.

Specifically, by mapping the pushing distance of the physical rocker to the movement velocity of the front sight in the game, the larger the pushing distance of the physical rocker is pushed in a short time. More specifically, the more violent the pushing is, the faster the movement velocity of the front sight is, the larger the movement distance of the front sight is within a preset period of time. When the front sight is close to the target virtual object, if the player needs to aim the front sight at the target virtual object, the player needs to push the rocker very restrainedly and cautiously, which requires the player to have a very high operation ability to push the rocker by a micro-distance, thereby ensuring that the front sight is adjusted by a micro-distance in the game scenario. However, since this operation requires a high control ability of the player, it is difficult for the player to achieve precise aiming, thereby bringing negative game experience to the player.

Relevant solutions to the above technical problems mainly include: in the game level, when the front sight is located within a preset range of the target virtual object, the target virtual object is automatically adsorbed to achieve aiming; and in the physical level, a heightened rocker cap is additionally provided on the physical rocker, so that when the player needs to control the front sight to move by a preset distance, the player needs to push the physical rocker to move by a longer distance, thereby reducing the sensitivity of the physical rocker, and improving the error tolerance rate for controlling the physical rocker to move by the player.

For example, referring to FIG. 6, which is a schematic diagram of heightening the physical rocker. As shown in FIG. 6, when physical rockers of different heights are controlled to move by an equal angle, different physical rockers need to be pushed to move by distances D1 and D2 respectively. Therefore, the larger the height of the physical rocker is, the longer the pushing distance is required, i.e., reducing the difficulty in precise operation of the physical rocker.

However, in the above solutions, for the automatic adsorption solution, due to misoperation or too fast operation frequency of the player, the front sight that have been automatically adsorbed may be made to move away from the target virtual object again, which is not conducive to the game experience of the player. However, the solution of heightening the rocker cap may reduce the operation difficulty to a certain extent, but requires additional fittings, and the use of the heightened rocker cap for some players may reduce the players' experience in holding the gamepad, so that the players are more prone to operation fatigue.

One embodiment of the present disclosure is intended to provide a solution for achieving precise aiming in the scenario where the player interacts with and controls the game scenario through the gamepad. In this embodiment, the above step S41 of generating, in response to the single implementation of the precise aiming control operation, the single precise aiming control instruction may comprise generating, in response to the single precise aiming control operation inputted through a gamepad connected to the terminal device, the single precise aiming control instruction.

In this embodiment, the player inputs an aiming control operation through the physical rocker to control the front sight to move by a certain movement distance, and enters the precise control mode after determining that the condition for precise control of the front sight is satisfied. The player's control operation for the physical rocker is the precise aiming control operation, the single precise aiming control instruction is generated based on the single precise aiming control operation inputted by the player through the physical rocker, and the front sight is controlled to move by the constant first preset distance once based on the single precise aiming control instruction.

In an implementation, if the gamepad does not have a processing power, in the precise control mode, the terminal device determines and controls the front sight of the controlled virtual object to move by the first preset distance based on the precise aiming control instruction generated for the precise aiming control operation of the physical rocker.

In another implementation, if the gamepad has a processing power, in the precise control mode, the gamepad determines the first preset distance based on the precise aiming control instruction generated based on the precise aiming control operation of the physical rocker, and transmits the first preset distance to the terminal device, so that the terminal device controls the front sight to move by the first preset distance.

The method for game control provided in the above embodiments comprises controlling, after determining that the condition for precise control of the front sight is satisfied and in response to the single precise aiming control operation inputted through a gamepad connected to the terminal device, the front sight to move by the constant first preset distance, so that the player aims at the target virtual object through a plurality of precise aiming control operations, thereby reducing the requirements for the player's operation ability to push the rocker by a micro-distance, reducing the difficulty in precise control by the player without the need for additional hardware fittings, not only improving the game experience of the player, but also facilitating the promotion of the game to more ordinary users for experience, reducing the game round duration, reducing the power consumption of the terminal, and reducing the operation pressure of the server.

A variety of implementations for determining that the condition for precise control of the front sight is satisfied are described below with reference to a variety of embodiments.

In one of implementations of the present disclosure, referring to FIG. 7, which is a schematic flowchart IV of a method for game control provided in an embodiment of the present disclosure. As shown in FIG. 7, the above step S30 of determining that the condition for precise control of the front sight is satisfied may comprise the following steps.

S31: detecting whether a distance between the front sight and the target virtual object is smaller than a second preset distance.

S32: determining, in response to the distance between the front sight and the target virtual object being smaller than the second preset distance, that the condition for precise control of the front sight is satisfied.

In this embodiment, the condition for precise control of the front sight is that the distance between the front sight and the target virtual object is smaller than the second preset distance. When controlling the front sight to move in the game scenario based on the aiming control operation, the terminal device detects the distance between the front sight and the target virtual object, determines that the controlled virtual object satisfies the condition for precise control of the front sight when the distance between the front sight and the target virtual object is smaller than the second preset distance, and enters the precise control mode.

In some embodiments, if the game scenario comprises a plurality of other virtual objects in addition to the controlled virtual object controlled by the player, in order to facilitate the aiming of the front sight, after a further virtual object enters the visual field of the controlled virtual object. More specfiically, the further virtual object enters the graphical user screen of the terminal device, the further virtual object may be determined as the target virtual object, and then whether the distance between the front sight and the target virtual object is smaller than the second preset distance is detected.

The method for game control provided in the above embodiments comprises determining, after detecting that the distance between the front sight and the target virtual object is smaller than the second preset distance, that the controlled virtual object satisfies the condition for precise control of the front sight, and entering the precise control mode, thereby avoiding the problem that the player fails to aim at the target virtual object due to failure to precisely input the aiming control operation, ensuring that the player can aim at the target virtual object through a plurality of precise aiming control operations, improving the game experience of the player, reducing the game round duration, reducing the power consumption of the terminal, and reducing the operation pressure of the server.

In one embodiment of the present disclosure, the above step S30 of determining that the condition for precise control of the front sight is satisfied may comprise determining, in response to a received precise control instruction, that the condition for precise control of the front sight is satisfied.

In this embodiment, when controlling the front sight to move in the game scenario through the aiming control operation, the player can determine by himself whether he needs to enter the precise control mode, and can input a precise control instruction to the terminal device if the player determines that he needs to enter the precise control mode based on his own game needs or his own experience. After receiving the precise control instruction, the terminal device determines that the controlled virtual object satisfies the condition for precise control of the front sight, and enters the precise control mode.

The method for game control provided in the above embodiments comprises determining, after receiving the precise control instruction, that the controlled virtual object satisfies the condition for precise control of the front sight, entering the precise control mode to avoid the problem that the player fails to aim at the target virtual object due to failure to precisely input the aiming control operation, and inputting a precise control operation to make the front sight enter the precise control mode, thereby ensuring that the player can aim at the target virtual object through a plurality of precise aiming control operations, improving the game experience of the player, reducing the game round duration, reducing the power consumption of the terminal, and reducing the operation pressure of the server.

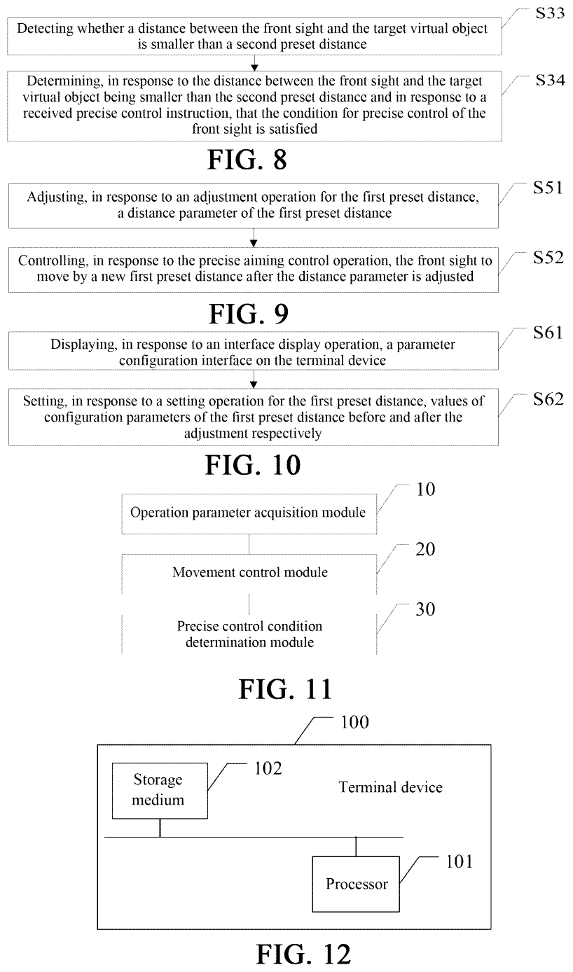

In another embodiment of the present disclosure, referring to FIG. 8, which is a schematic flowchart V of a method for game control provided in an embodiment of the present disclosure. As shown in FIG. 8, the above step S30 of determining that the condition for precise control of the front sight is satisfied may comprise the following steps.

S33: detecting whether a distance between the front sight and the target virtual object is smaller than a second preset distance.

S34: determining, in response to the distance between the front sight and the target virtual object being smaller than the second preset distance and in response to a received precise control instruction, that the condition for precise control of the front sight is satisfied.

In this embodiment, if the player would like to improve his own macro-distance operation ability, or the player may not need to aim at the target virtual object. More specifically, the player does not need to enter the precise control mode when the distance between the front sight and the target virtual object is smaller than the second preset distance; or, in order to prevent the player from improperly entering the precise control mode due to improper input of the precise control instruction during the game, the condition for precise control of the front sight is set to a dual control condition.

Specifically, the dual control condition may be the condition that the distance between the front sight and the target virtual object is smaller than the second preset distance and the precise control instruction is received. When the player controls the front sight to move in the game scenario through the aiming control operation, if the distance between the front sight and the target virtual object is detected to be smaller than the second preset distance and the precise control instruction is received, the condition for precise control of the front sight is determined to be satisfied, and the precise control mode is entered.

In some embodiments, when the player controls the front sight to move in the game scenario, if the distance between the front sight and the target virtual object is detected to be smaller than the second preset distance, but no precise control instruction is received, it is determined that the player does not need to aim at the target virtual object; or the player needs to input the aiming control operation by himself to move by a micro-distance to aim at the target virtual object, and it is determined that it is not necessary to enter the precise control mode.

In some other embodiments, when the player controls the front sight to move in the game scenario, if a precise control instruction is received, but the distance between the front sight and the target virtual object is detected to be larger than or equal to the second preset distance, it is determined that the precise control instruction inputted by the player may be a misoperation, and it is determined that it is not necessary to enter the precise control mode.

In a possible implementation, a function of setting the condition for precise control of the front sight can be provided for the player, so that the player selects a method for determining that the condition for precise control of the front sight is satisfied from the above three possible implementations based on his own needs, thereby flexibly setting the condition for precise control of the front sight, improving the game experience of the player, reducing the game round duration, reducing the power consumption of the terminal, and reducing the operation pressure of the server.

The method for game control provided in the above embodiments comprises determining, after detecting that the distance between the front sight and the target virtual object is smaller than the second preset distance and receiving the precise control instruction, that the controlled virtual object satisfies the condition for precise control of the front sight, and entering the precise control mode, which can, on the one hand, allow the player to flexibly choose whether to use the precise control mode for aiming or use his own macro-distance operation ability for aiming; and can, on the other hand, prevent the player from improperly inputting the precise control instruction during the game, thereby improving the game experience of the player, reducing the game round duration, reducing the power consumption of the terminal, and reducing the operation pressure of the server.

In a scenario where the player directly interacts with and controls the game scenario through the terminal device, before the above determining, in response to the received precise control instruction, that the condition for precise control of the front sight is satisfied, the method may further comprise: generating, in response to a trigger operation of a preset precise control widget in the graphical user interface, the precise control instruction.

In this embodiment, as shown in FIG. 1, the graphical user interface further comprises a preset precise control widget 14. When the player determines that the precise control mode needs to be entered, the precise control instruction is generated through the trigger operation inputted through the precise control widget 14 in the graphical user interface.

In a scenario where the player interacts with and controls the game scenario through a gamepad, before the above determining, in response to the received precise control instruction, that the condition for precise control of the front sight is satisfied, the method may further comprise generating, in response to a pressing operation inputted through a preset button on a gamepad connected to the terminal device, the precise control instruction.

In this embodiment, the preset button on the gamepad has a precise control function, and the precise control instruction can be generated through the pressing operation inputted for the preset button.

In some embodiments, the above generating, in response to the pressing operation inputted through the preset button on the gamepad connected to the terminal device, the precise control instruction may comprise generating, in response to the pressing operation in a preset pressing mode inputted through a preset multi-function button, the precise control instruction.

Generally, the structure of gamepads provided on the market is fixed, and the gamepads involve many models. If a new function button is additionally provided on a gamepad for a newly designed function, it is not only costly, but also difficult to fully cover all models of gamepads, which is not conducive to the promotion and use of the new function.

For buttons existing on relevant gamepads, a precise control function is set in any button, and the original function and the precise control function of the button are distinguished by different pressing modes. In this embodiment, whether the pressing operation inputted through the preset multi-function button is received is detected, and if the pressing operation inputted through the preset multi-function button is received, whether the pressing mode of the pressing operation is the preset pressing mode for the precise control function is determined. If the pressing operation inputted through the preset multi-function button is received, and the pressing mode of the pressing operation is the preset pressing mode for the function of confirming the preset precise control condition, it is determined to generate the precise control instruction.

In some embodiments, the above step S34 of determining, in response to the distance between the front sight and the target virtual object being smaller than the second preset distance and in response to the received precise control instruction, that the condition for precise control of the front sight is satisfied may comprise determining, in response to the distance between the front sight and the target virtual object being smaller than the second preset distance, and the pressing operation in the preset pressing mode inputted through the preset multi-function button being received, that the controlled virtual object satisfies the condition for precise control of the front sight.

In a possible implementation, if the preset pressing mode is long press, the above step S40 of controlling, in response to the precise aiming control operation, the front sight to move by the constant first preset distance may comprise controlling, in response to the precise aiming control operation inputted through the physical rocker during long press of the preset multi-function button, the front sight of the controlled virtual object to move by the first preset distance, until the front sight is aimed at the target virtual object in the game scenario.

In this embodiment, the preset pressing mode is long press, which means that if the physical rocker needs to remain in the precise control mode, the player needs to input the pressing operation through the preset multi-function button throughout the whole process, and controls, while pressing the preset multi-function button throughout, the front sight of the controlled virtual object to move by the first preset distance based on the precise aiming control operation for the physical rocker. When the pressing operation for the preset multi-function button is canceled, the physical rocker exits the precise control mode, and after that, the front sight of the controlled virtual object is controlled to move by a response distance based on the aiming control operation of the player pushing the physical rocker.

In some embodiments, the preset pressing mode is long press. After the preset multi-function button is long pressed, the physical rocker is always in the precise control mode until the controlled virtual object no longer satisfies the preset precise control condition, and the physical rocker is controlled to exit the precise control mode.

The method for game control provided in the above embodiments comprises determining, after detecting the receipt of the pressing operation in the preset pressing mode inputted through the preset multi-function button on the gamepad, that the controlled virtual object satisfies the preset precise control condition, so that the physical rocker enters the precise control mode, setting the function for confirming the preset precise control condition in a button of the gamepad, and distinguishing the functions by different pressing modes without increasing the costs because of no need to change the structure of the relevant gamepad, which is more conducive to promotion, so that game players using different models can enjoy the advantage of reducing the difficulty in precise control brought by the method for game control in this embodiment.

Referring to FIG. 9, which is a schematic flowchart VI of a method for game control provided in an embodiment of the present disclosure. As shown in FIG. 9, the method may further comprise S51: adjusting, in response to an adjustment operation for the first preset distance, a distance parameter of the first preset distance.

When the distance between the front sight and the target virtual object is smaller than the first preset distance by which the front sight moves as controlled based on the precise aiming control operation, the target virtual object fails to be aimed at after the front sight is controlled to move by the first preset distance based on the precise aiming control operation. More specifically, the precision of the first preset distance does not satisfy the requirements, and it is necessary to improve the precision of the movement distance of the front sight controlled based on the precise aiming control operation.

In this embodiment, the distance parameter set for the first preset distance at least comprises two distance values, where, when the precise control mode is entered, the first preset distance adopts a first distance value, and the first distance value is larger than a second distance value.

When the player determines that the target virtual object cannot be aimed at by moving the front sight by the first distance value, the first preset distance needs to be adjusted. After the terminal device receives an adjustment operation for the first preset distance, the distance parameter of the first preset distance is switched from the first distance value to the second distance value. More specifically, the first preset distance after the adjustment is more precise than the first preset distance before the adjustment.

In a possible implementation, in a scenario where the player interacts with and controls the game scenario through a gamepad, before the above S51 of adjusting, in response to the adjustment operation for the first preset distance, the distance parameter of the first preset distance, the method may further comprise determining, in response to receiving a pressing operation inputted through at least two preset buttons, that the pressing operation inputted through the at least two preset buttons is the adjustment operation for the first preset distance.

If a first preset button has been preset with a precise control function, and since the first preset button further has a factory-preset function, if a function of adjusting the distance parameter is additionally provided on the first preset button, in order to distinguish the functions of the first preset button, it is necessary to set a plurality of different pressing modes, so that the pressing mode of the first preset button becomes complex, and the player is easily confused, thereby reducing the game experience of the player.

On this basis, in this embodiment, the distance parameter for the first preset distance is adjusted by using composite pressing of the at least two preset buttons. Specifically, in response to the received pressing operation inputted through the at least two preset buttons, the distance parameter of the first preset distance is adjusted.

In some embodiments, the at least two preset buttons may be: the first preset button and at least one further button, or at least two other buttons other than the first preset button.

S52: controlling, in response to the precise aiming control operation, the front sight to move by a new first preset distance after the distance parameter is adjusted.

In this embodiment, after the distance parameter of the first preset distance is adjusted and in response to the precise aiming control operation inputted by the player, the front sight of the controlled virtual object is controlled to move by the constant second distance value. More specifically, the precise aiming control operation of the player moves by any distance in any direction, the front sight of the controlled virtual object will move by the constant second distance value in the corresponding direction, and the front sight of the controlled virtual object is controlled to move by a plurality of second distance values through a plurality of precise aiming control operations inputted by the player, until the front sight is aimed at the target virtual object.

The method for game control provided in the above embodiments comprises adjusting the distance parameter of the first preset distance based on the adjustment operation for the first preset distance, to control the front sight to move by the new first preset distance after the distance parameter is adjusted based on the precise aiming control operation, thereby more precisely aiming at the target virtual object, improving the movement precision of the front sight without macro-distance control, facilitating aiming the controlled virtual object at the target virtual object, reducing the operation difficulty of the player, improving the game experience of the player, reducing the game round duration, reducing the power consumption of the terminal, and reducing the operation pressure of the server.

In some embodiments, the above process S51 of adjusting, in response to the adjustment operation for the first preset distance, the distance parameter of the first preset distance may comprise adjusting, in response to a plurality of adjustment operations for the first preset distance, the distance parameter of the first preset distance based on a parameter adjustment level corresponding to the number of adjustments.

In this embodiment, when the player controls the front sight of the controlled virtual object to move, as the distance between the front sight and the target virtual object is continuously shortened, the movement distance of the front sight expected by the player is also continuously shortened, a corresponding relationship between the number of adjustments and the parameter adjustment levels is preset, and distance parameters of the first preset distance corresponding to different parameter adjustment levels have different values, where the larger the number of adjustments is, the higher the parameter adjustment level is, the smaller the value of the distance parameter corresponding to the first preset distance is, and the higher the precision of the first preset distance is. The parameter adjustment level corresponding to the number of adjustments is determined based on the number of adjustments of adjustment operations of the player for the first preset distance, and the adjustment parameter of the first preset distance is adjusted based on the distance parameter corresponding to the parameter adjustment level.

It should be noted that the number of adjustment operations is continuously accumulated after the precise control mode is entered.

In some other embodiments, the above process S51 of adjusting, in response to the adjustment operation for the first preset distance, the distance parameter of the first preset distance may comprise adjusting, in response to the adjustment operation for the first preset distance for a preset duration, the distance parameter of the first preset distance based on a parameter adjustment level corresponding to the duration.

In this embodiment, after entering the precise control mode, the player expects to move the front sight by different distances through the precise aiming control operation based on different distances between the front sight and the target virtual object. The farther the distance between the front sight and the target virtual object is, the longer the distance by which the front sight moves through the precise aiming control operation is expected by the player. Otherwise, the closer the distance between the front sight and the target virtual object is, the shorter the distance by which the front sight moves through the precise aiming control operation is expected by the player.

A corresponding relationship between the duration of the adjustment operation and the parameter adjustment level is preset, and distance parameters of the first preset distance corresponding to different parameter adjustment levels have different values, where the longer the duration of the adjustment operation is, the higher the parameter adjustment level is, the smaller the value of the distance parameter corresponding to the first preset distance is, and the higher the precision of the first preset distance is. The parameter adjustment level corresponding to the duration is determined based on the duration of the adjustment operation of the player for the first preset distance, and the adjustment parameter of the first preset distance is adjusted based on the distance parameter corresponding to the parameter adjustment level.

The method for game control provided in the above embodiments comprises adjusting the distance parameter of the first preset distance based on the number of adjustments or the duration of the adjustment operation for the first preset distance and based on the parameter adjustment level corresponding to the number of adjustments or the duration, so that the player can flexibly adjust the distance parameter of the first preset distance, and more precisely aim at the target virtual object, thus improving the game experience of the player.

Referring to FIG. 10, which is a schematic flowchart VII of a method for game control provided in an embodiment of the present disclosure. As shown in FIG. 10, the method may further comprise the following steps.

S61: displaying, in response to an interface display operation, a parameter configuration interface on the terminal device.

S62: setting, in response to a setting operation for the first preset distance, values of configuration parameters of the first preset distance before and after the adjustment respectively.

In this embodiment, based on the interface display operation inputted by the player, a parameter configuration interface is displayed on a display interface of the terminal device, and the parameter configuration interface comprises a plurality of parameters. Configuration parameters of the first preset distance comprise: configuration parameters before the adjustment and configuration parameters after the adjustment. The values of the configuration parameters before the adjustment and after the adjustment are modified respectively based on setting operations inputted by the player respectively for the configuration parameters before the adjustment and the configuration parameters after the adjustment.

It should be noted that if the player interacts with and controls the game scenario through the gamepad, since the gamepad itself does not have a display interface, in order to facilitate setting the relevant parameters of the gamepad by the player, it needs to be completed through the display interface of the terminal device communicatively connected to the gamepad. The interface display operation for the gamepad and the setting operation for the first preset distance may be operations inputted through corresponding function buttons on the gamepad, or may be operations inputted through the terminal device, which is not limited in this embodiment.

The method for game control provided in the above embodiments comprises displaying the parameter configuration interface on the display interface of the terminal device, and modifying the values of the configuration parameters before the adjustment and the configuration parameters after the adjustment, thereby controlling the front sight to move through the precise aiming control operation based on modified parameters of the first preset distance, flexibly setting the configuration parameters of the first preset distance, improving the game experience of the player, reducing the game round duration, reducing the power consumption of the terminal, and reducing the operation pressure of the server.

Based on the above method embodiments, an embodiment of the present disclosure further provides an apparatus for game control. Referring to FIG. 11, which is a schematic structural diagram of an apparatus for game control provided in an embodiment of the present disclosure. As shown in FIG. 11, the apparatus for game control may comprise: an operation parameter acquisition module 10 configured to acquire, in response to an aiming control operation, an operation parameter of the aiming control operation; and a movement control module 20 configured to control a movement distance of a front sight based on the operation parameter, where the operation parameter is positively correlated with the movement distance, and the front sight is an aiming mark displayed on the graphical user interface.

In a possible implementation, the movement control module 20 comprises: a movement velocity determination unit configured to determine a movement velocity of the front sight based on the operation parameter; and a movement distance determination unit configured to determine the movement distance of the front sight based on a duration of the aiming control operation and the movement velocity.

In a possible implementation, the operation parameter is an operation distance, and the movement velocity determination unit is specifically configured to determine the movement velocity of the front sight based on the operation distance, where the operation distance is positively correlated with the movement velocity.

The precise control condition determination module 30 is configured to determine that a condition for precise control of the front sight is satisfied.

The movement control module 20 is further configured to control, in response to a precise aiming control operation, the front sight to move by a constant first preset distance.

In a possible implementation, the movement control module 20 further comprises: a control instruction generation unit configured to generate, in response to a single implementation of the precise aiming control operation, a single precise aiming control instruction; and a movement control unit configured to control a single movement of the front sight by the constant first preset distance based on the single precise aiming control instruction, where the constant first preset distance is pre-mapped for the precise aiming control instruction.

The apparatus for game control provided in the above embodiments controls, based on the operation parameter corresponding to the aiming control operation, the front sight to move based on the movement distance corresponding to the operation parameter, and controls, after determining that the condition for precise control of the front sight is satisfied and in response to the precise aiming control operation, the front sight to move by the constant first preset distance, so that a player aims at the target virtual object through a plurality of precise aiming control operations, thereby reducing the requirements for the player's operation ability and the difficulty in precise control, not only improving the game experience of the player, but also facilitating the promotion of a game to more ordinary users for experience, reducing the game round duration, reducing the power consumption of the terminal, and reducing the operation pressure of a server.

In a possible implementation, the control instruction generation unit is specifically configured to generate, in response to the single implementation of the precise aiming control operation for a preset movement widget in the graphical user interface, the single precise aiming control instruction.

The apparatus for game control provided in the above embodiments controls, after determining that the condition for precise control of the front sight is satisfied and in response to the single precise aiming control operation for the preset movement widget in the graphical user interface, the front sight to move by the constant first preset distance, so that the player aims at the target virtual object through a plurality of precise aiming control operations, thereby reducing the requirements for the player's operation ability and the difficulty in precise control, not only improving the game experience of the player, but also facilitating the promotion of the game to more ordinary users for experience, reducing the game round duration, reducing the power consumption of the terminal, and reducing the operation pressure of the server.

In another possible implementation, the control instruction generation unit is specifically configured to generate, in response to the single precise aiming control operation inputted through a gamepad connected to the terminal device, the single precise aiming control instruction.

The apparatus for game control provided in the above embodiments controls, after determining that the condition for precise control of the front sight is satisfied and in response to the single precise aiming control operation inputted through a gamepad connected to the terminal device, the front sight to move by the constant first preset distance, so that the player aims at the target virtual object through a plurality of precise aiming control operations, thereby reducing the requirements for the player's operation ability to push the rocker by a micro-distance, reducing the difficulty in precise control by the player without the need for additional hardware fittings, not only improving the game experience of the player, but also facilitating the promotion of the game to more ordinary users for experience, reducing the game round duration, reducing the power consumption of the terminal, and reducing the operation pressure of the server.

In one of implementations of the present disclosure, the precise control condition determination module 30 is specifically configured to detect whether the distance between the front sight and the target virtual object is smaller than a second preset distance; and determine, in response to the distance between the front sight and the target virtual object is smaller than the second preset distance, that the condition for precise control of the front sight is satisfied.

In one embodiment of the present disclosure, the precise control condition determination module 30 is further configured to determine, in response to a received precise control instruction, that the condition for precise control of the front sight is satisfied.

The apparatus for game control provided in the above embodiments determines, after receiving the precise control instruction, that the controlled virtual object satisfies the condition for precise control of the front sight, and enters the precise control mode to avoid the problem that the player fails to aim at the target virtual object due to failure to precisely input the aiming control operation, so that the front sight enters the precise control mode by inputting a precise control instruction, thereby ensuring that the player can aim at the target virtual object through a plurality of precise aiming control operations, improving the game experience of the player, reducing the game round duration, reducing the power consumption of the terminal, and reducing the operation pressure of the server.

In another embodiment of the present disclosure, the precise control condition determination module 30 is further configured to detect whether the distance between the front sight and the target virtual object is smaller than the second preset distance; and determine, in response to the distance between the front sight and the target virtual object being smaller than the second preset distance and in response to a received precise control instruction, that the condition for precise control of the front sight is satisfied.

The apparatus for game control provided in the above embodiments determines, after detecting that the distance between the front sight and the target virtual object is smaller than the second preset distance and in response to receiving the precise control instruction, that the controlled virtual object satisfies the condition for precise control of the front sight, and enters the precise control mode, which can, on the one hand, allow the player to flexibly choose whether to use the precise control mode for aiming or use his own macro-distance operation ability for aiming; and can, on the other hand, prevent the player from improperly inputting the precise control instruction during the game, thereby improving the game experience of the player, reducing the game round duration, reducing the power consumption of the terminal, and reducing the operation pressure of the server.

In a scenario where the player directly interacts with and controls the game scenario through the terminal device, the apparatus further comprises a control instruction generation module configured to generate, in response to a trigger operation of a preset precise control widget in the graphical user interface, the precise control instruction.

In a scenario where the player interacts with and controls the game scenario through a gamepad, the control instruction generation module is further configured to generate, in response to a pressing operation inputted through a preset button on the gamepad connected to the terminal device, the precise control instruction.

The apparatus for game control provided in the above embodiments determines, after detecting the receipt of the pressing operation in the preset pressing mode inputted through the preset multi-function button on the gamepad, that the controlled virtual object satisfies the preset precise control condition, so that the physical rocker enters the precise control mode, sets the function for confirming the preset precise control condition in a button of the gamepad, and distinguishes the functions by different pressing modes without increasing the costs because of no need to change the structure of the relevant gamepad, which is more conducive to promotion, so that game players using different models can enjoy the advantage of reducing the difficulty in precise control brought by the method for game control in this embodiment.

In one embodiment, the apparatus further comprises: a distance parameter adjustment module configured to adjust, in response to an adjustment operation for the first preset distance, a distance parameter of the first preset distance.

The movement control module 20 is further configured to control, in response to the precise aiming control operation, the front sight to move by a new first preset distance after the distance parameter is adjusted.

The apparatus for game control provided in the above embodiments adjusts the distance parameter of the first preset distance based on the adjustment operation for the first preset distance, to control the front sight to move by the new first preset distance after the distance parameter is adjusted based on the precise aiming control operation, thereby more precisely aiming at the target virtual object, improving the movement precision of the front sight without macro-distance control, facilitating aiming the controlled virtual object at the target virtual object, reducing the operation difficulty of the player, improving the game experience of the player, reducing the game round duration, reducing the power consumption of the terminal, and reducing the operation pressure of the server.

In some embodiments, the distance parameter adjustment module is specifically configured to adjust, in response to a plurality of adjustment operations for the first preset distance, the distance parameter of the first preset distance based on a parameter adjustment level corresponding to the number of adjustments.

In some other embodiments, the distance parameter adjustment module is specifically configured to adjust, in response to the adjustment operation for the first preset distance for a preset duration, the distance parameter of the first preset distance based on a parameter adjustment level corresponding to the duration.

The apparatus for game control provided in the above embodiments adjusts the distance parameter of the first preset distance based on the number of adjustments or the duration of the adjustment operation for the first preset distance and based on the parameter adjustment level corresponding to the number of adjustments or the duration, so that the player can flexibly adjust the distance parameter of the first preset distance, and more precisely aim at the target virtual object, thus improving the game experience of the player.

In one embodiment, the apparatus further comprises: an interface display module configured to display, in response to an interface display operation, a parameter configuration interface on the terminal device; and a parameter adjustment module configured to set, in response to a setting operation for the first preset distance, values of configuration parameters of the first preset distance before and after the adjustment respectively.

The apparatus for game control provided in the above embodiments displays the parameter configuration interface on the display interface of the terminal device, and modifies the values of the configuration parameters before the adjustment and the configuration parameters after the adjustment, thereby controlling the front sight to move through the precise aiming control operation based on modified parameters of the first preset distance, flexibly setting the configuration parameters of the first preset distance, improving the game experience of the player, reducing the game round duration, reducing the power consumption of the terminal, and reducing the operation pressure of the server.

The above apparatus is configured to execute the method provided in the above embodiments, and has similar implementation principles and technical effects, which will not be repeated here.

The above modules may be one or more integrated circuits configured to implement the above method, such as: one or more Application Specific Integrated Circuits (abbreviated as ASIC), or one or more microprocessors, or one or more Field Programmable Gate Arrays (abbreviated as FPGA). For another example, when one of the above modules is implemented in the form of a processing element scheduling program code, the processing element may be a general-purpose processor, such as a Central Processing Unit (abbreviated as CPU) or other processors capable of invoking a program code. For example, these modules may be integrated together and implemented in the form of a system-on-a-chip (SOC).

Referring to FIG. 12, which is a schematic diagram of a terminal device provided in the present disclosure. As shown in FIG. 12, the terminal device 100 comprises: a processor 101, a storage medium 102, and a bus. The storage medium 102 stores a program instruction executable by the processor 101. When the terminal device 100 is running, the processor 101 communicates with the storage medium 102 through the bus, and the processor 101 executes the program instruction to execute the above method for game control.

Specifically, the steps of the above method for game control implemented by the processor include: acquiring, in response to an aiming control operation, an operation parameter of the aiming control operation; controlling a movement distance of a front sight based on the operation parameter; determining that a condition for precise control of the front sight is satisfied; and controlling, in response to a precise aiming control operation, the front sight to move by a constant first preset distance.

In a possible implementation, the above step of controlling the movement distance of the front sight based on the operation parameter implemented by the processor may comprise: determining a movement velocity of the front sight based on the operation parameter; and determining the movement distance of the front sight based on a duration of the aiming control operation and the movement velocity.

In a possible implementation, the operation parameter is an operation distance, and the above step of determining the movement velocity of the front sight based on the operation parameter implemented by the processor may comprise determining the movement velocity of the front sight based on the operation distance, where the operation distance is positively correlated with the movement velocity.

In a possible implementation, the above step of controlling, in response to the precise aiming control operation, the front sight to move by the constant first preset distance implemented by the processor may comprise: generating, in response to a single implementation of the precise aiming control operation, a single precise aiming control instruction; and controlling a single movement of the front sight by the constant first preset distance based on the single precise aiming control instruction, where the constant first preset distance is pre-mapped for the precise aiming control instruction.

The method for game control implemented by the processor in the above embodiments comprises controlling, based on the operation parameter corresponding to the aiming control operation, the front sight to move based on the movement distance corresponding to the operation parameter, and controlling, after determining that the condition for precise control of the front sight is satisfied and in response to the precise aiming control operation, the front sight to move by the constant first preset distance, so that a player aims at the target virtual object through a plurality of precise aiming control operations, thereby reducing the requirements for the player's operation ability and the difficulty in precise control, not only improving the game experience of the player, but also facilitating the promotion of a game to more ordinary users for experience, reducing the game round duration, reducing the power consumption of the terminal, and reducing the operation pressure of a server.

In a possible implementation, in a scenario where a player directly interacts with and controls a game scenario through a terminal device, the above step of generating, in response to the single implementation of the precise aiming control operation, the single precise aiming control instruction implemented by the processor may comprise generating, in response to the single implementation of the precise aiming control operation for a preset movement widget in the graphical user interface, the single precise aiming control instruction.

The method for game control implemented by the processor in the above embodiments comprises controlling, after determining that the condition for precise control of the front sight is satisfied and in response to the single precise aiming control operation for the preset movement widget in the graphical user interface, the front sight to move by the constant first preset distance, so that the player aims at the target virtual object through a plurality of precise aiming control operations, thereby reducing the requirements for the player's operation ability and the difficulty in precise control, not only improving the game experience of the player, but also facilitating the promotion of the game to more ordinary users for experience, reducing the game round duration, reducing the power consumption of the terminal, and reducing the operation pressure of the server.

In another possible implementation, in a scenario where the player interacts with and controls a game scenario through a gamepad, the above step of generating, in response to the single implementation of the precise aiming control operation, the single precise aiming control instruction implemented by the processor may comprise generating, in response to the single precise aiming control operation inputted through a gamepad connected to the terminal device, the single precise aiming control instruction.

The method for game control implemented by the processor in the above embodiments comprises controlling, after determining that the condition for precise control of the front sight is satisfied and in response to the single precise aiming control operation inputted through a gamepad connected to the terminal device, the front sight to move by the constant first preset distance, so that the player aims at the target virtual object through a plurality of precise aiming control operations, thereby reducing the requirements for the player's operation ability to push the rocker by a micro-distance, reducing the difficulty in precise control by the player without the need for additional hardware fittings, not only improving the game experience of the player, but also facilitating the promotion of the game to more ordinary users for experience, reducing the game round duration, reducing the power consumption of the terminal, and reducing the operation pressure of the server.

In one embodiment of the present disclosure, the above step of determining that the condition for precise control of the front sight is satisfied implemented by the processor may comprise detecting whether a distance between the front sight and the target virtual object is smaller than a second preset distance; and determining, in response to the distance between the front sight and the target virtual object being smaller than the second preset distance, that the condition for precise control of the front sight is satisfied.

The method for game control implemented by the processor in the above embodiments comprises, determining, after detecting that the distance between the front sight and the target virtual object is smaller than the second preset distance, that the controlled virtual object satisfies the condition for precise control of the front sight, and entering the precise control mode, thereby avoiding the problem that the player fails to aim at the target virtual object due to failure to precisely input the aiming control operation, ensuring that the player can aim at the target virtual object through a plurality of precise aiming control operations, improving the game experience of the player, reducing the game round duration, reducing the power consumption of the terminal, and reducing the operation pressure of the server.

In one embodiment of the present disclosure, the above step of determining that the condition for precise control of the front sight is satisfied implemented by the processor may comprise determining, in response to a received precise control instruction, that the condition for precise control of the front sight is satisfied.

The method for game control implemented by the processor in the above embodiments comprises determining, after receiving the precise control instruction, that the controlled virtual object satisfies the condition for precise control of the front sight, and entering the precise control mode to avoid the problem that the player fails to aim at the target virtual object due to failure to precisely input the aiming control operation, so that the front sight enters the precise control mode by inputting a precise control instruction, thereby ensuring that the player can aim at the target virtual object through a plurality of precise aiming control operations, improving the game experience of the player, reducing the game round duration, reducing the power consumption of the terminal, and reducing the operation pressure of the server.

In one of implementations of the present disclosure, the above step of determining that the condition for precise control of the front sight is satisfied implemented by the processor may comprise: detecting whether a distance between the front sight and the target virtual object is smaller than a second preset distance; and determining, in response to the distance between the front sight and the target virtual object being smaller than the second preset distance and in response to a received precise control instruction, that the condition for precise control of the front sight is satisfied.

The method for game control implemented by the processor in the above embodiments comprises determining, after detecting that the distance between the front sight and the target virtual object is smaller than the second preset distance and receiving the precise control instruction, that the controlled virtual object satisfies the condition for precise control of the front sight, and entering the precise control mode, which can, on the one hand, allow the player to flexibly choose whether to use the precise control mode for aiming or use his own macro-distance operation ability for aiming; and can, on the other hand, prevent the player from improperly inputting the precise control instruction during the game, thereby improving the game experience of the player, reducing the game round duration, reducing the power consumption of the terminal, and reducing the operation pressure of the server.

In a scenario where the player directly interacts with and controls the game scenario through the terminal device, before the processor implements the above determining, in response to the received precise control instruction, that the condition for precise control of the front sight is satisfied, the processor may further generate, in response to a trigger operation of a preset precise control widget in the graphical user interface, the precise control instruction.

In a scenario where the player interacts with and controls the game scenario through a gamepad, before the processor implements the above determining, in response to the received precise control instruction, that the condition for precise control of the front sight is satisfied, the processor may further generate, in response to a pressing operation inputted through a preset button on a gamepad connected to the terminal device, the precise control instruction.

The method for game control implemented by the processor in the above embodiments comprises determining, after detecting the receipt of the pressing operation in the preset pressing mode inputted through the preset multi-function button on the gamepad, that the controlled virtual object satisfies the preset precise control condition, so that the physical rocker enters the precise control mode, setting the function for confirming the preset precise control condition in a button of the gamepad, and distinguishing the functions by different pressing modes without increasing the costs because of no need to change the structure of the gamepad, which is more conducive to promotion, so that game players using different models can enjoy the advantage of reducing the difficulty in precise control brought by the method for game control in this embodiment.

In a possible implementation, the steps of the above method for game control implemented by the processor further comprise: adjusting, in response to an adjustment operation for the first preset distance, a distance parameter of the first preset distance; and controlling, in response to the precise aiming control operation, the front sight to move by a new first preset distance after the distance parameter is adjusted.

The method for game control implemented by the processor in the above embodiments comprises adjusting the distance parameter of the first preset distance based on the adjustment operation for the first preset distance, to control the front sight to move by the new first preset distance after the distance parameter is adjusted based on the precise aiming control operation, thereby more precisely aiming at the target virtual object, improving the movement precision of the front sight without macro-distance control, facilitating aiming the controlled virtual object at the target virtual object, reducing the operation difficulty of the player, improving the game experience of the player, reducing the game round duration, reducing the power consumption of the terminal, and reducing the operation pressure of the server.

In a possible implementation, the above process of adjusting, in response to the adjustment operation for the first preset distance, the distance parameter of the first preset distance implemented by the processor may comprise adjusting, in response to a plurality of adjustment operations for the first preset distance, the distance parameter of the first preset distance based on a parameter adjustment level corresponding to the number of adjustments.

In another possible implementation, the above process of adjusting, in response to the adjustment operation for the first preset distance, the distance parameter of the first preset distance implemented by the processor may comprise adjusting, in response to the adjustment operation for the first preset distance for a preset duration, the distance parameter of the first preset distance based on a parameter adjustment level corresponding to the duration.

The method for game control implemented by the processor in the above embodiments comprises adjusting the distance parameter of the first preset distance based on the number of adjustments or the duration of the adjustment operation for the first preset distance and based on the parameter adjustment level corresponding to the number of adjustments or the duration, so that the player can flexibly adjust the distance parameter of the first preset distance, and more precisely aim at the target virtual object, thus improving the game experience of the player.

In a possible implementation, the steps of the above method for game control implemented by the processor further comprise: displaying, in response to an interface display operation, a parameter configuration interface on the terminal device; and setting, in response to a setting operation for the first preset distance, values of configuration parameters of the first preset distance before and after the adjustment respectively.

The method for game control implemented by the processor in the above embodiments comprises displaying the parameter configuration interface on the display interface of the terminal device, and modifying the values of the configuration parameters before the adjustment and the configuration parameters after the adjustment, thereby controlling the front sight to move through the precise aiming control operation based on modified parameters of the first preset distance, flexibly setting the configuration parameters of the first preset distance, improving the game experience of the player, reducing the game round duration, reducing the power consumption of the terminal, and reducing the operation pressure of the server.

One embodiment of the present disclosure further provides a computer-readable storage medium, storing a computer program thereon, where the computer program, when run by a processor, implements steps of the above method for game control.

Specifically, the steps of the above method for game control implemented by the computer program comprise: acquiring, in response to an aiming control operation, an operation parameter of the aiming control operation; controlling a movement distance of a front sight based on the operation parameter; determining that a condition for precise control of the front sight is satisfied; and controlling, in response to a precise aiming control operation, the front sight to move by a constant first preset distance.

In a possible implementation, the above step of controlling the movement distance of the front sight based on the operation parameter implemented by the computer program may comprise: determining a movement velocity of the front sight based on the operation parameter; and determining the movement distance of the front sight based on a duration of the aiming control operation and the movement velocity.

In a possible implementation, the operation parameter is an operation distance, and the above step of determining the movement velocity of the front sight based on the operation parameter implemented by the computer program may comprise determining the movement velocity of the front sight based on the operation distance, where the operation distance is positively correlated with the movement velocity.

In a possible implementation, the above step of controlling, in response to the precise aiming control operation, the front sight to move by the constant first preset distance implemented by the computer program may comprise generating, in response to a single implementation of the precise aiming control operation, a single precise aiming control instruction; and controlling a single movement of the front sight by the constant first preset distance based on the single precise aiming control instruction, where the constant first preset distance is pre-mapped for the precise aiming control instruction.

The method for game control implemented by the computer program in the above embodiments comprises controlling, based on the operation parameter corresponding to the aiming control operation, the front sight to move based on the movement distance corresponding to the operation parameter, and controlling, after determining that the condition for precise control of the front sight is satisfied and in response to the precise aiming control operation, the front sight to move by the constant first preset distance, so that a player aims at the target virtual object through a plurality of precise aiming control operations, thereby reducing the requirements for the player's operation ability and the difficulty in precise control, not only improving the game experience of the player, but also facilitating the promotion of a game to more ordinary users for experience, reducing the game round duration, reducing the power consumption of the terminal, and reducing the operation pressure of a server.

In a possible implementation, in a scenario where a player directly interacts with and controls a game scenario through a terminal device, the above step of generating, in response to the single implementation of the precise aiming control operation, the single precise aiming control instruction implemented by the computer program may comprise generating, in response to the single implementation of the precise aiming control operation for a preset movement widget in the graphical user interface, the single precise aiming control instruction.

The method for game control implemented by the computer program in the above embodiments comprises controlling, after determining that the condition for precise control of the front sight is satisfied and in response to the single precise aiming control operation for the preset movement widget in the graphical user interface, the front sight to move by the constant first preset distance, so that the player aims at the target virtual object through a plurality of precise aiming control operations, thereby reducing the requirements for the player's operation ability and the difficulty in precise control, not only improving the game experience of the player, but also facilitating the promotion of the game to more ordinary users for experience, reducing the game round duration, reducing the power consumption of the terminal, and reducing the operation pressure of the server.

In another possible implementation, in a scenario where the player interacts with and controls the game scenario through a gamepad, the above step of generating, in response to the single implementation of the precise aiming control operation, the single precise aiming control instruction implemented by the computer program may comprise generating, in response to the single precise aiming control operation inputted through a gamepad connected to the terminal device, the single precise aiming control instruction.

The method for game control implemented by the computer program in the above embodiments comprises controlling, after determining that the condition for precise control of the front sight is satisfied and in response to the single precise aiming control operation inputted through a gamepad connected to the terminal device, the front sight to move by the constant first preset distance, so that the player aims at the target virtual object through a plurality of precise aiming control operations, thereby reducing the requirements for the player's operation ability to push the rocker by a micro-distance, reducing the difficulty in precise control by the player without the need for additional hardware fittings, not only improving the game experience of the player, but also facilitating the promotion of the game to more ordinary users for experience, reducing the game round duration, reducing the power consumption of the terminal, and reducing the operation pressure of the server.

In the first possible implementation, the above step of determining that the condition for precise control of the front sight is satisfied implemented by the computer program may comprise: detecting whether a distance between the front sight and the target virtual object is smaller than a second preset distance; and determining, in response to the distance between the front sight and the target virtual object being smaller than the second preset distance, that the condition for precise control of the front sight is satisfied.

The method for game control implemented by the computer program in the above embodiments comprises determining, after detecting that the distance between the front sight and the target virtual object is smaller than the second preset distance, that the controlled virtual object satisfies the condition for precise control of the front sight, and entering the precise control mode, thereby avoiding the problem that the player fails to aim at the target virtual object due to failure to precisely input the aiming control operation, ensuring that the player can aim at the target virtual object through a plurality of precise aiming control operations, improving the game experience of the player, reducing the game round duration, reducing the power consumption of the terminal, and reducing the operation pressure of the server.

In one embodiment of the present disclosure, the above step of determining that the condition for precise control of the front sight is satisfied implemented by the computer program may comprise determining, in response to a received precise control instruction, that the condition for precise control of the front sight is satisfied.

The method for game control implemented by the computer program in the above embodiments comprises determining, after receiving the precise control instruction, that the controlled virtual object satisfies the condition for precise control of the front sight, and entering the precise control mode to avoid the problem that the player fails to aim at the target virtual object due to failure to precisely input the aiming control operation, so that the front sight enters the precise control mode by inputting a precise control instruction, thereby ensuring that the player can aim at the target virtual object through a plurality of precise aiming control operations, improving the game experience of the player, reducing the game round duration, reducing the power consumption of the terminal, and reducing the operation pressure of the server.

In one embodiment of the present disclosure, the above step of determining that the condition for precise control of the front sight is satisfied implemented by the computer program may comprise: detecting whether a distance between the front sight and the target virtual object is smaller than a second preset distance; and determining, in response to the distance between the front sight and the target virtual object being smaller than the second preset distance and in response to a received precise control instruction, that the condition for precise control of the front sight is satisfied.

The method for game control implemented by the computer program in the above embodiments comprises determining, after detecting that the distance between the front sight and the target virtual object is smaller than the second preset distance and receiving the precise control instruction, that the controlled virtual object satisfies the condition for precise control of the front sight, and entering the precise control mode, which can, on the one hand, allow the player to flexibly choose whether to use the precise control mode for aiming or use his own macro-distance operation ability for aiming; and can, on the other hand, prevent the player from improperly inputting the precise control instruction during the game, thereby improving the game experience of the player, reducing the game round duration, reducing the power consumption of the terminal, and reducing the operation pressure of the server.

In a scenario where the player directly interacts with and controls the game scenario through the terminal device, before the computer program implements the above determining, in response to the received precise control instruction, that the condition for precise control of the front sight is satisfied, the computer program may further generate, in response to a trigger operation of a preset precise control widget in the graphical user interface, the precise control instruction.

In a scenario where the player interacts with and controls the game scenario through a gamepad, before the computer program implements the above determining, in response to the received precise control instruction, that the condition for precise control of the front sight is satisfied, the computer program may further generate, in response to a pressing operation inputted through a preset button on a gamepad connected to the terminal device, the precise control instruction.

The method for game control implemented by the computer program in the above embodiments comprises determining, after detecting the receipt of the pressing operation in the preset pressing mode inputted through the preset multi-function button on the gamepad, that the controlled virtual object satisfies the preset precise control condition, so that the physical rocker enters the precise control mode, setting the function for confirming the preset precise control condition in a button of the gamepad, and distinguishing the functions by different pressing modes without increasing the costs because of no need to change the structure of the gamepad, which is more conducive to promotion, so that game players using different models can enjoy the advantage of reducing the difficulty in precise control brought by the method for game control in this embodiment.

In a possible implementation, the steps of the above method for game control implemented by the computer program further comprise: adjusting, in response to an adjustment operation for the first preset distance, a distance parameter of the first preset distance; and controlling, in response to the precise aiming control operation, the front sight to move by a new first preset distance after the distance parameter is adjusted.

The method for game control implemented by the computer program in the above embodiments comprises adjusting the distance parameter of the first preset distance based on the adjustment operation for the first preset distance, to control the front sight to move by the new first preset distance after the distance parameter is adjusted based on the precise aiming control operation, thereby more precisely aiming at the target virtual object, improving the movement precision of the front sight without macro-distance control, facilitating aiming the controlled virtual object at the target virtual object, reducing the operation difficulty of the player, improving the game experience of the player, reducing the game round duration, reducing the power consumption of the terminal, and reducing the operation pressure of the server.

In a possible implementation, the above process of adjusting, in response to the adjustment operation for the first preset distance, the distance parameter of the first preset distance implemented by the computer program may comprise adjusting, in response to a plurality of adjustment operations for the first preset distance, the distance parameter of the first preset distance based on a parameter adjustment level corresponding to the number of adjustments.

In another possible implementation, the above process of adjusting, in response to the adjustment operation for the first preset distance, the distance parameter of the first preset distance implemented by the computer program may comprise adjusting, in response to the adjustment operation for the first preset distance for a preset duration, the distance parameter of the first preset distance based on a parameter adjustment level corresponding to the duration.

The method for game control implemented by the computer program in the above embodiments comprises adjusting the distance parameter of the first preset distance based on the number of adjustments or the duration of the adjustment operation for the first preset distance and based on the parameter adjustment level corresponding to the number of adjustments or the duration, so that the player can flexibly adjust the distance parameter of the first preset distance, and more precisely aim at the target virtual object, thus improving the game experience of the player.

In a possible implementation, the steps of the above method for game control implemented by the computer program further comprise displaying, in response to an interface display operation, a parameter configuration interface on the terminal device; and setting, in response to a setting operation for the first preset distance, values of configuration parameters of the first preset distance before and after the adjustment respectively.

The method for game control implemented by the computer program in the above embodiments comprises displaying the parameter configuration interface on the display interface of the terminal device, and modifying the values of the configuration parameters before the adjustment and the configuration parameters after the adjustment, thereby controlling the front sight to move through the precise aiming control operation based on modified parameters of the first preset distance, flexibly setting the configuration parameters of the first preset distance, improving the game experience of the player, reducing the game round duration, reducing the power consumption of the terminal, and reducing the operation pressure of the server.

It should be understood that the apparatus and the method disclosed in the embodiments provided in the present disclosure may be implemented in other ways. For example, the apparatus embodiments described above are merely illustrative. For example, the division of the units is only a logical function division and there may be other manners of division during actual implementations. For example, a plurality of units or components may be combined or may be integrated into another system, or some features may be omitted or may not be performed. In addition, the illustrated or discussed coupling or direct coupling or communicative connection between each other may be indirect coupling or communicative connection among apparatuses or units via some interfaces, and may be electrical connection, mechanical connection, or other forms of connection.

The units described as separate components may or may not be physically separated, the components illustrated as units may or may not be physical units. More specifically, they may be located in a same place or may be distributed to a plurality of network units. A part or all of the units may be selected based on actual requirements to achieve the purpose of the solutions of this embodiment.

In addition, the functional units in various embodiments of the present disclosure may be integrated into one processing unit, or each unit may be physically present alone, or two or more than two units may be integrated into one unit. The above integrated unit may be implemented in the form of hardware, or may be implemented in the form of hardware with the addition of software functional units.

The integrated unit implemented in the form of the above-mentioned software functional unit may be stored in a computer-readable storage medium. The above-mentioned software functional unit is stored in a storage medium, and includes some instructions for causing a computer device (which may be a personal computer, a server, a network device, or the like) or a processor to implement some steps of the method according to the embodiments of the present disclosure. The above storage medium includes: various mediums that can store a program code, such as a U disk, a mobile hard disk, a Read-Only Memory (abbreviated as ROM), a Random Access Memory (abbreviated as RAM), a magnetic disk, or an optical disk.

While merely specific embodiments of the present disclosure are provided above, the scope of protection of the present disclosure is not limited to the specific embodiments. Any person skilled in the art can easily conceive of alterations or replacements within the technical scope disclosed in the present disclosure. All these alterations or replacements should be encompassed within the scope of protection of the present disclosure. Therefore, the scope of protection of the present disclosure should be determined by the scope of protection of the claims.

1. A method for game control, comprising:
acquiring, in response to an aiming control operation, an operation parameter of the aiming control operation, wherein a graphical user interface is provided by a terminal device, the graphical user interface comprising a game scenario and a controlled virtual object located in the game scenario, the controlled virtual object corresponding to the terminal device;
controlling a movement distance of a front sight based on the operation parameter, wherein the operation parameter is positively correlated with the movement distance, and the front sight is an aiming mark displayed via the graphical user interface;
determining that a condition for precise control of the front sight is satisfied; and
controlling, in response to a precise aiming control operation, the front sight to move constantly by a first preset distance.

2. The method according to claim 1, wherein controlling the movement distance of the front sight based on the operation parameter comprises:
determining a movement velocity of the front sight based on the operation parameter; and
determining the movement distance of the front sight based on a duration of the aiming control operation and the movement velocity.

3. The method according to claim 2, wherein the operation parameter comprises an operation distance, and determining the movement velocity of the front sight based on the operation parameter comprises:
determining the movement velocity of the front sight based on the operation distance, wherein the operation distance is positively correlated with the movement velocity.

4. The method according to claim 1, wherein controlling, in response to the precise aiming control operation, the front sight to move constantly by the first preset distance comprises:
generating, in response to a single implementation of the precise aiming control operation, a single precise aiming control instruction; and
controlling a single movement of the front sight by the first preset distance based on the single precise aiming control instruction, wherein the first preset distance is pre-mapped into the single precise aiming control instruction.

5. The method according to claim 4, wherein generating, in response to the single implementation of the precise aiming control operation, the single precise aiming control instruction comprises:
generating, in response to the single implementation of the precise aiming control operation on a preset movement control element within in the graphical user interface, the single precise aiming control instruction.

6. The method according to claim 4, wherein generating, in response to the single implementation of the precise aiming control operation, the single precise aiming control instruction comprises:
generating, in response to the single precise aiming control operation input through a gamepad connected to the terminal device, the single precise aiming control instruction.

7. The method according to claim 1, wherein the game scenario further comprises a target virtual object, and determining that the condition for precise control of the front sight is satisfied comprises:
detecting whether a distance between the front sight and the target virtual object is smaller than a second preset distance; and
determining, in response to the distance between the front sight and the target virtual object being smaller than the second preset distance, that the condition for precise control of the front sight is satisfied.

8. The method according to claim 1, wherein the game scenario further comprises a target virtual object, and determining that the condition for precise control of the front sight is satisfied comprises:
determining, in response to receiving precise control instruction, that the condition for precise control of the front sight is satisfied.

9. The method according to claim 1, wherein the game scenario further comprises a target virtual object, and determining that the condition for precise control of the front sight is satisfied comprises:
detecting whether a distance between the front sight and the target virtual object is smaller than a second preset distance; and
determining, in response to the distance between the front sight and the target virtual object being smaller than the second preset distance and in response to receiving a precise control instruction, that the condition for precise control of the front sight is satisfied.

10. The method according to claim 8, further comprising:
generating, in response to a trigger operation on a preset precise control element within in the graphical user interface, the precise control instruction.

11. The method according to claim 8, further comprising:
generating, in response to a pressing operation input through a preset button on a gamepad connected to the terminal device, the precise control instruction.

12. The method according to claim 1, further comprising:
adjusting, in response to an adjustment operation for the first preset distance, a distance parameter of the first preset distance; and
controlling, in response to the precise aiming control operation, the front sight to move by the adjusted first preset distance.

13. The method according to claim 12, wherein adjusting, in response to the adjustment operation for the first preset distance, the distance parameter of the first preset distance comprises:
adjusting, in response to a plurality of adjustment operations for the first preset distance, the distance parameter of the first preset distance based on a parameter adjustment level corresponding to the plurality of adjustment operations.

14. The method according to claim 12, wherein adjusting, in response to the adjustment operation for the first preset distance, the distance parameter of the first preset distance comprises:
adjusting, in response to the adjustment operation for a preset duration of the first preset distance, the distance parameter of the first preset distance based on a parameter adjustment level corresponding to the preset duration.

15. The method according to claim 12, further comprising:
displaying, in response to an interface display operation, a parameter configuration interface on the terminal device; and
setting, in response to a setting operation for the first preset distance, configuration parameter values of the first preset distance before the adjustment operation and after the adjustment operation.

16. (canceled)

17. A system, comprising:
one or more memories collectively containing one or more programs; and
one or more processors, wherein the one or more processors are configured to, individually or collectively, perform an operation comprising:
acquiring, in response to an aiming control operation, an operation parameter of the aiming control operation, wherein a graphical user interface is provided by a terminal device, the graphical user interface comprising a game scenario and a controlled virtual object located in the game scenario, the controlled virtual object corresponding to the terminal device;
controlling a movement distance of a front sight based on the operation parameter, wherein the operation parameter is positively correlated with the movement distance, and the front sight is an aiming mark displayed via the graphical user interface;
determining that a condition for precise control of the front sight is satisfied; and
controlling, in response to a precise aiming control operation, the front sight to move constantly by a first preset distance.

18. One or more non-transitory computer-readable storage media containing, in any combination, computer program code that, when executable by a computer system, perform an operation comprising:
acquiring, in response to an aiming control operation, an operation parameter of the aiming control operation, wherein a graphical user interface is provided by a terminal device, the graphical user interface comprising a game scenario and a controlled virtual object located in the game scenario, the controlled virtual object corresponding to the terminal device;
controlling a movement distance of a front sight based on the operation parameter, wherein the operation parameter is positively correlated with the movement distance, and the front sight is an aiming mark displayed via the graphical user interface;
determining that a condition for precise control of the front sight is satisfied; and
controlling, in response to a precise aiming control operation, the front sight to move constantly by a first preset distance.

19. The system according to claim 17, wherein controlling the movement distance of the front sight based on the operation parameter comprises:
determining a movement velocity of the front sight based on the operation parameter; and
determining the movement distance of the front sight based on a duration of the aiming control operation and the movement velocity.

20. The system according to claim 19, wherein the operation parameter comprises an operation distance, and determining the movement velocity of the front sight based on the operation parameter comprises:
determining the movement velocity of the front sight based on the operation distance, wherein the operation distance is positively correlated with the movement velocity.

21. The system according to claim 17, wherein controlling, in response to the precise aiming control operation, the front sight to move constantly by the first preset distance comprises:
generating, in response to a single implementation of the precise aiming control operation, a single precise aiming control instruction; and
controlling a single movement of the front sight by the first preset distance based on the single precise aiming control instruction, wherein the first preset distance is pre-mapped into the single precise aiming control instruction.
